(19) United States
(12) Patent Application Publication
(10) Pub. No.: US 2023/0412594 A1
(43) Pub. Date: Dec. 21, 2023

(54) TYING ADDRESSES TO AUTHENTICATION PROCESSES

(71) Applicant: MICRO FOCUS LLC, SANTA CLARA, CA (US)

(72) Inventors: DOUGLAS MAX GROVER, RIGBY, ID (US); MICHAEL F. ANGELO, HOUSTON, TX (US)

(73) Assignee: MICRO FOCUS LLC, SANTA CLARA, CA (US)

(21) Appl. No.: 17/844,580

(22) Filed: Jun. 20, 2022

(51) Int. Cl. H04L 9/40; H04L 61/5014

(52) U.S. Cl. CPC H04L 63/0876; H04L 61/5014; H04L 63/0869; H04L 63/126

(57) ABSTRACT

A request to authenticate is received (e.g., a request to login with a username/password). The request to authenticate comprises an address associated with the request to authenticate (e.g., an IP address). The request to authenticate is validated. In response to validating the request to authenticate, a message is sent to a routing device that identifies the address as authenticated for routing packets. In a second embodiment, a DHCP discover message is received. The DHCP discover message is a request to get an IP address. A determination is made to determine if the DHCP discover message comprises a watermark. In response to determining that the DHCP discover message comprises the watermark: a DHCP offer message is sent with an IP address and a third message is sent to a routing device that identifies the IP address as valid for routing packets.

### FIELD

The disclosure relates generally to network security and particularly to identifying unauthorized use of addresses on a network.

### BACKGROUND

Identifying malicious activities on a network is extraordinarily complex because it is sometimes difficult to identify whether an activity is benign or malicious. Current solutions require searching through voluminous amounts of data (e.g., terra bytes of data in real-time) in order to identify unauthorized use of Internet Protocol (IP) addresses. Moreover, monitoring the use of IP addresses to detect malicious use of IP addresses that use Dynamic Host Configuration Protocol (DHCP) is difficult to do because the IP addresses in DHCP are dynamic, making it difficult to track an ever-changing use of IP addresses.

### SUMMARY

These and other needs are addressed by the various embodiments and configurations of the present disclosure. The present disclosure can provide a number of advantages depending on the particular configuration. These and other advantages will be apparent from the disclosure contained herein.

A request to authenticate is received (e.g., a request to login with a username/password). The request to authenticate comprises an address associated with the request to authenticate (e.g., an IP address). The request to authenticate is validated. In response to validating the request to authenticate, a message is sent to a routing device that identifies the address as authenticated for routing packets.

In a second embodiment, a DHCP discover message is received. The DHCP discover message is a request to get an IP address. A determination is made to determine if the DHCP discover message comprises a watermark. In response to determining that the DHCP discover message comprises the watermark: a DHCP offer message is sent with an IP address and a third message is sent to a routing device that identifies the IP address as valid for routing packets.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein and in the claims, the term “routing device” can be or may include any device that routes packets on a network, such as, a router, a firewall, a hub, a gateway, a proxy server, and/or the like.

As described herein, and in the claims, the term “associated address” is an address specifically associated with an authentication process. The associated address requires more than just having an address being used in packets where the user/process authenticates. Instead, the associated address is an address that is specifically designated to be associated with the authentication process. For example, the authentication process may specifically designate the associated address (e.g., an IP address) where the associated IP address is sent along with the authentication credentials (e.g., at the application layer using encryption) in an authentication message even though the packets associated with the authentication request also use the same IP address at the network layer (i.e., the address at the network layer would not be considered an associated address unless it is specifically identified as an associated address by some other means). In other words, just sending packets with an IP address to authenticate does not mean that there is an associated IP address. The process requires a specific designation of the address to be considered an authenticated address. Designating an associated address may be done in a variety of ways, such as, in the authentication request, in a separate message, based on an administration, based on an event, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for tying addresses to an authentication process.

FIG. 2 is a flow diagram of a process for tying addresses to an authentication process.

FIG. 3 is a flow diagram of a process for tying addresses to an authentication process where the user logins in locally.

FIG. 4 is a flow diagram of a process for using watermarks with a DHCP server.

FIG. 5 is a flow diagram of a process for detecting the use of unauthorized addresses.

FIG. 6 is a flow diagram of a process for using machine learning to identify user usage patterns of authenticated addresses.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

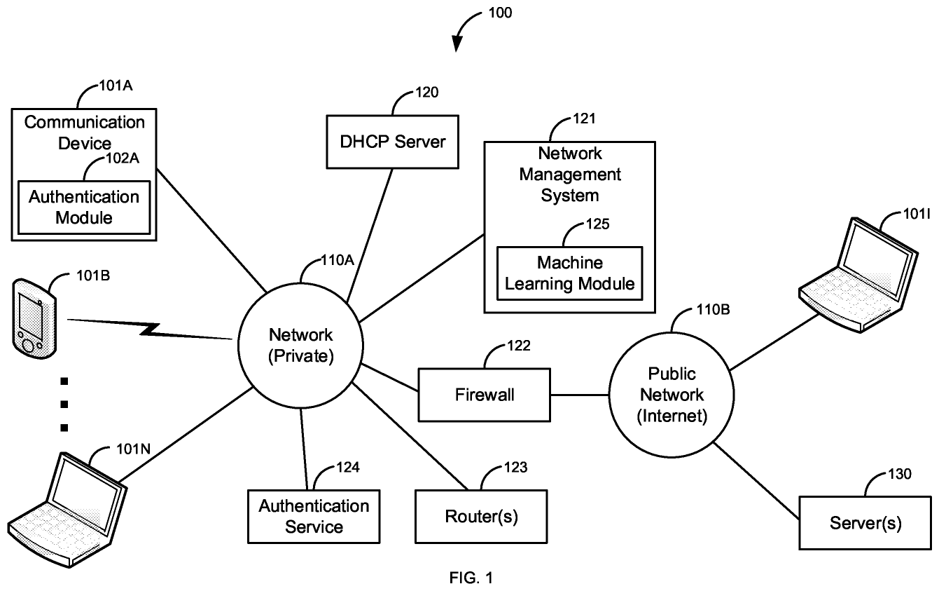

FIG. 1 is a block diagram of a first illustrative system 100 for tying addresses to an authentication process. The first illustrative system 100 comprises communication devices 101A-101N, a private network 110A, a public network 110B, a DHCP server 120, a network management system 121, a firewall 122, router(s) 123, an authentication service 124, a communication device 101I, and server(s) 130.

The communication devices 101A-101N and 101I can be or may include any device that can communicate on the networks 110A-110B, such as a Personal Computer (PC), a telephone, a video system, a cellular telephone, a Personal Digital Assistant (PDA), a tablet device, a notebook device, a smartphone, a server, a gateway, an application server, a database server, and/or the like. As shown in FIG. 1, any number of communication devices 101A-101N may be connected to the private network 110A. Although FIG. 1 only show a single communication device 101I connected to the public network 110B, there may be any number of communication devices 101 connected to the public network 110B.

The communication device 101A further comprises an authentication module 102A. The authentication module 101A is used to authenticate using the authentication service 124. The authentication module 102A may reside permanently on the communication device 101A or may be downloaded (e.g., a web page that is downloaded to a browser). Although not shown for convenience, the communication device 101B-101N may also have a respective authentication module (i.e., 102B-102N).

The network 110A is a private network (e.g., a corporate network 110A) and the network 110B is a public network 110B (e.g., the Internet). However, in other embodiments, the networks 110A-110B may be various combinations of public/private networks 110. The networks 110A-110B can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The networks 110A-110B can use a variety of electronic protocols, such as Ethernet, Internet Protocol (IP), Hyper Text Transfer Protocol (HTTP), Web Real-Time Protocol (Web RTC), and/or the like. Thus, the networks 110A-110B are electronic communication networks configured to carry messages via packets and/or circuit switched communications. The networks 110A-110B may comprise multiple networks 110.

The DHCP server 120 may be a server that conforms to the DHCP standard as defined in Network Working Group RFC 2131, March 1997 titled “Dynamic Host Configuration Protocol” (e.g., see https://datatracker.ietf.org/doc/html/rfc2131), which is incorporated herein by reference. The DHCP server 120 may use some aspects of the standard DHCP process in addition to some of the embodiments described herein. The DHCP server 120 may provide dynamic IP addresses to the communication devices 101A-101N, the firewall 122, the router(s) 123, and the authentication service 124 per the DHCP protocol. In addition, some of the communication devices 101A-101N, the firewall 122, the router(s) 123, and/or the authentication service 124 may use static IP addresses instead of dynamic IP addresses provided by the DHCP server 120.

The network management system 121 can be or may include any network management system 121 that can provide monitoring/security services for the private network 110A. The network management system 121 may be used to: monitor packets on the private network 110A for anomalies, monitor packets on the private network 110A for the use of unauthorized IP addresses, monitor packets on the private network 110A to identify potential security breaches, administer network services, and/or the like.

The network management system 121 comprises a machine learning module 125. The machine learning module 125 may use a variety of machine learning algorithms, such as, supervised machine learning, unsupervised machine learning, reinforcement machine learning, semi-supervised machine learning, self-supervised machine learning, multi-instance machine learning, inductive machine learning, deductive machine learning, transductive machine learning, and/or the like. The machine learning module 125 may be used to identify anomalous behavior of authenticated addresses/unauthenticated addresses in the private network 110A based on usage patterns of the addresses.

The firewall 122 can be any device configured to provide security between the private network 110A and the public network 110B. The firewall 122 may be used to block/allow various types of communications through the firewall 122, such as, blocking specific types of incoming communications, blocking specific types of outgoing communications, blocking specific ports, providing Network Address Translation (NAT) services, and/or the like. The firewall 122 may be administered, may have predefined configurations, and/or the like. The firewall 122 may block specific addresses, such as, specific IP addresses.

The router(s) 123 can be or may include any hardware device that is used to route packets on the private network 110A. The router(s) 123 may route packets between different networks 110/communication devices 101 within the private network 110A.

The authentication service 124 can be or may include any service that can authenticate a user, an application, a device, a process, a service, and/or the like. The authentication service 124 may provide multiple authentication levels (i.e., multi-factor authentication) to allow access within the private network 110A and to communication device 101I/server(s) 130 on the public network 110B.

The server(s) 130 may be any device that can provide services for the communication devices 101A-101N/101I. For example, the server(s) 130 may be a web server, an application server, a communication server (e.g., a Private Branch Exchange), a financial server, an electronic shopping server, a social media network, a database server, a security server, and/or the like.

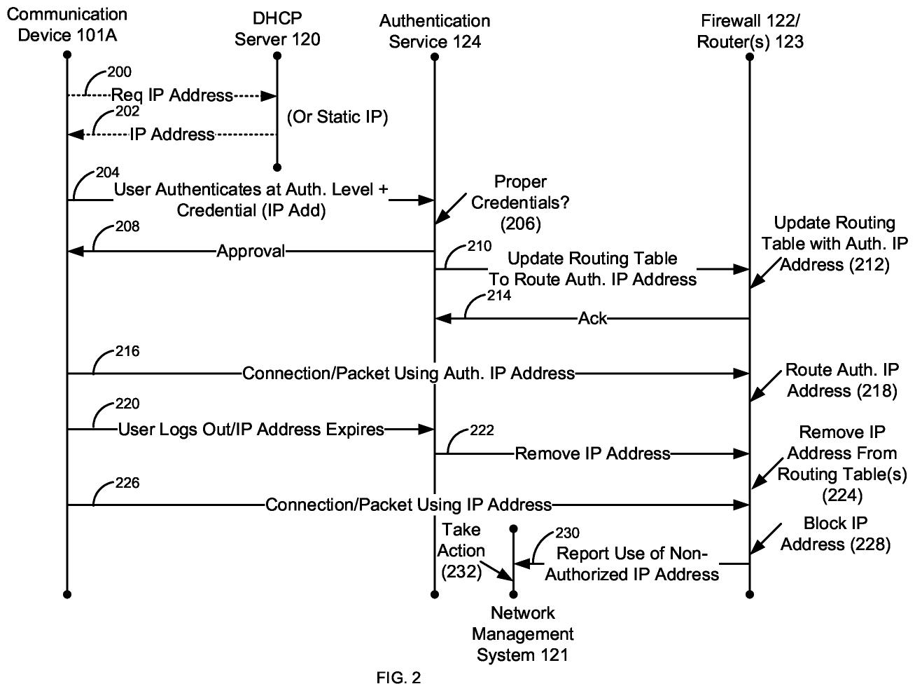

FIG. 2 is a flow diagram of a process for tying addresses to an authentication process. Although the processes described in FIGS. 2-6 are described using the IP protocol, the process described herein are not limited to the IP protocol. Illustratively, the communication devices 101A-101N/101I, the authentication modules 102A-101N, the DHCP server 120, the network management system 121, the firewall 122, the router(s) 123, the application server 124, and the server(s) 130 are stored-program-controlled entities, such as a computer or microprocessor, which performs the method of FIGS. 2-6 and the processes described herein by executing program instructions stored in a computer readable storage medium, such as a memory (i.e., a computer memory, a hard disk, and/or the like). Although the methods described in FIGS. 2-6 are shown in a specific order, one of skill in the art would recognize that the steps in FIGS. 2-6 may be implemented in different orders and/or be implemented in a multi-threaded environment. Moreover, various steps may be omitted or added based on implementation.

When the communication device 101A first powers up, the communication device 101A will either get an assigned static IP address or the communication device 101A requests, in step 200, and IP address from the DHCP server 120. The DHCP server 120 sends, in step 202, the IP address to the communication device 101A (e.g., using standard DHCP protocols). The user (could also be an application/process as well) then authenticates using an authentication level in step 204 to the authentication service 124. For example, the user may have two authentication levels: 1) where the user provides a username/password (level one), and 2) where the user provides a username/password and a SMS code (level two). The authentication process/levels may involve any type of login credential(s), such as, a username/password, an SMS code, an email code, biometrics (e.g., fingerprints, iris scans, voiceprints, etc.), digital certificates, questions, and/or the like. The authentication levels/factors may be different for different communication devices 101. For example, a higher authentication level may be need for a communication device 101 that requires additional security (e.g., three authentication factors). In one embodiment, there may only be a single authentication level.

The authentication message of step 204 may also include the IP address received in step 202 (or the static IP address) and a user credential. The IP address/credential may be encrypted in the authentication message. The credential is to prevent IP spoofing/man-in-the middle attacks. The credential may be a domain certificate issued by a certificate authority. The authentication message of step 204 may include other information and/or associated addresses. For example, the authentication message of step 204 may have a MAC address, a port number(s) of application(s), transport layer/presentation layer/application layer addresses, and/or the like. This additional information may be encrypted. The additional information may be stored locally on the authentication service 124 as configuration information.

The authentication service 124 determines, in step 206, if the user (or application/device etc.) provided the proper authentication credentials (e.g., the proper username/password, proper SMS code, proper biometric, etc.). If the user has provided the proper credentials in step 206, the authentication service 124 sends an approval message in step 208 to the communication device 101A. Although not shown, if the proper credentials were not provided in step 206, a reject message may be sent to the communication device 101A instead of the approval message of step 208. In addition, an update routing table message is sent, in step 210, to the firewall(s) 122 and/or the router(s) 123 that includes the authenticated IP address. The update routing table message of step 210 may include other information, such as, a MAC address, port number(s), transport layer/presentation layer/application layer addresses and/or the like. The firewall(s) 122/router(s) 123 updates their respective routing table(s) with the authenticated IP address in step 212. The firewall(s) 122/router(s) 123 acknowledge the update routing table message in step 214.

At this point, when a packet with the authenticated IP address is received at the firewall(s) 122/router(s) 123 in step 216, the packet is routed as would normally be done in step 218. If the user logs out or the IP address expires in step 220, the authentication service 124 sends a remove IP address message, in step 222, to the firewall 122/router(s) 123. The message of step 220 may come from the DHCP server 120 instead of communication device 101A (e.g., where the IP address expires). The DHCP server 120 sends a remove IP address message to the firewall 122/router(s) 123 in step 222. The firewall 122/router(s) 123 remove the IP address from the routing tables in step 224. When a connection/packet that uses the IP address is received in step 226, the firewall 122/router(s) 123 block the packet/connection with the IP address in step 228. The firewall 122/router(s) 123 then send a message that reports the use of the non-authorized IP address to the network management system 121 in step 230.

The network management system 121 may then take an action based on the report of the non-authorized IP address in step 232. For example, the action may be to identify the non-authorized IP address in a log file, alert a user (e.g., via email or text), automatically bring up a graphical user interface, identify a network device, shutdown a network device, shutdown an application, quarantine an application, quarantine a device, initiate a virus scan, open up a network management system 121 and display statistics associated with the non-authorized IP address, block a port on the firewall 122, and/or the like.

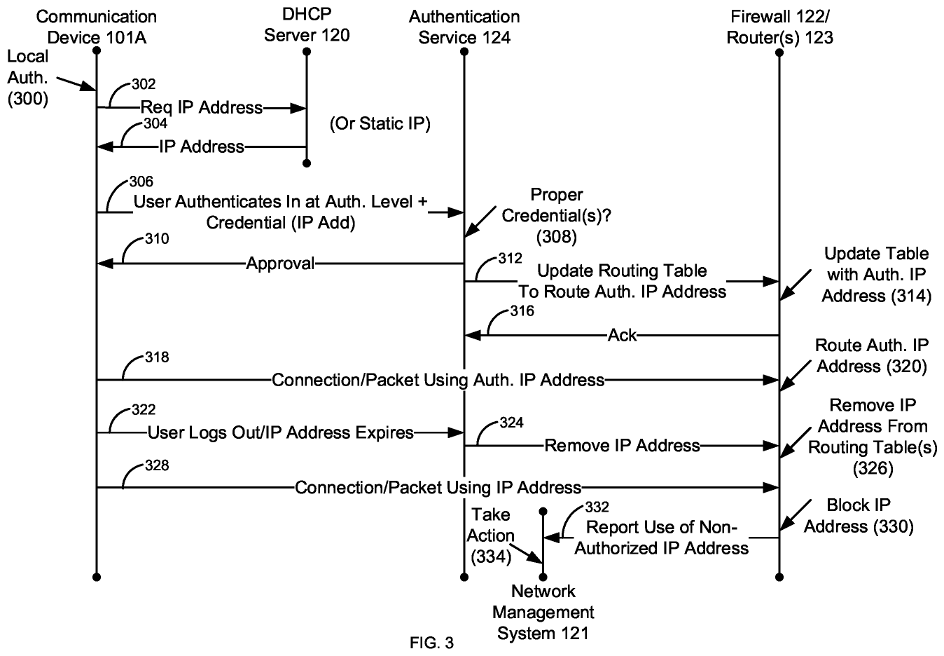

FIG. 3 is a flow diagram of a process for tying addresses to an authentication process where the user logins in locally. The process of FIG. 3 uses DHCP where the allocation of the IP address does not occur until the user authenticates locally in step 300. Once the user authenticates locally to the communication device 101A in step 300, the communication device 101A requests an IP address from the DHCP server 120 in step 302. The DHCP server 120 sends, in step 304, the IP address to the communication device 101A.

The user (could also be an application/process as well) then authenticates using an authentication level in step 306 to the authentication service 124 (e.g., like discussed above in FIG. 2). The authentication message of step 306 may also include the IP address received in step 304 and a user credential. The IP address/credential may be encrypted in the authentication message. The credential is to prevent IP spoofing/man-in-the middle attacks. The credential may be a domain certificate issued by a certificate authority. The authentication message of step 306 may include other information/addresses. For example, the authentication message of step 306 may have an associated addresses, such as, a MAC address, a port number(s) of application(s), transport layer/presentation layer/application layer addresses, and/or the like. This additional information may also be encrypted.

The authentication service 124 determines, in step 308, if the user (or application/device etc.) provided the proper authentication credential(s) (e.g., the proper username/password, proper SMS code, proper biometric, etc.). If the user has provided the proper credential(s) in step 308, the authentication service 124 sends an approval message in step 310 to the communication device 101A. Although not shown, if the proper credential(s) were not provided in step 308, a reject message may be sent to the communication device 101A instead of the approval message of step 310. In addition, an update routing table message is sent, in step 312, to the firewall(s) 122 and/or the router(s) 123 that includes the authenticated IP address. The update routing table message of step 312 may include other information, such as, a MAC address, port number(s), transport layer/presentation layer/application layer addresses and/or the like. The firewall(s) 122/router(s) 123 update their respective routing table(s) with the authenticated IP address in step 314. The firewall(s) 122/router(s) 123 acknowledge the update routing table message in step 316.

At this point, when a packet with the authenticated IP address is received at the firewall(s) 122/router(s) 123 in step 318, the packet is routed as would normally be done in step 320. If the user logs out or the IP address expires in step 322, the authentication service 124 sends a remove IP address message in step 324 to the firewall 122/router(s) 123. The message of step 322 may come from the DHCP server 120 instead of communication device 101A (e.g., where the IP address expires). The firewall 122/router(s) 123 remove the IP address from the routing tables in step 326. When a connection/packet that uses the IP address is received in step 328, the firewall 122/router(s) 123 block the connection/packet that uses the IP address in step 330. The firewall 122/router(s) 123 then send a message that reports the use of the non-authorized IP address to the network management system 121 in step 332.

The network management system 121 may then take an action based on the report of the non-authorized IP address in step 334. For example, the action may be to identify the non-authorized IP address in a log file, alert a user (e.g., via email or text), automatically bring up a graphical user interface, identify network device, shutdown a network device, shutdown an application, quarantine an application, quarantine a device, initiate a virus scan, open up a network management system 121 and display statistics associated with the non-authorized IP address, block a port on the firewall 122, and/or the like.

This process of FIG. 3 will work even for static IP addresses. In this embodiment, the communication device 101A does not allow access to the network 110A until the user authenticates.

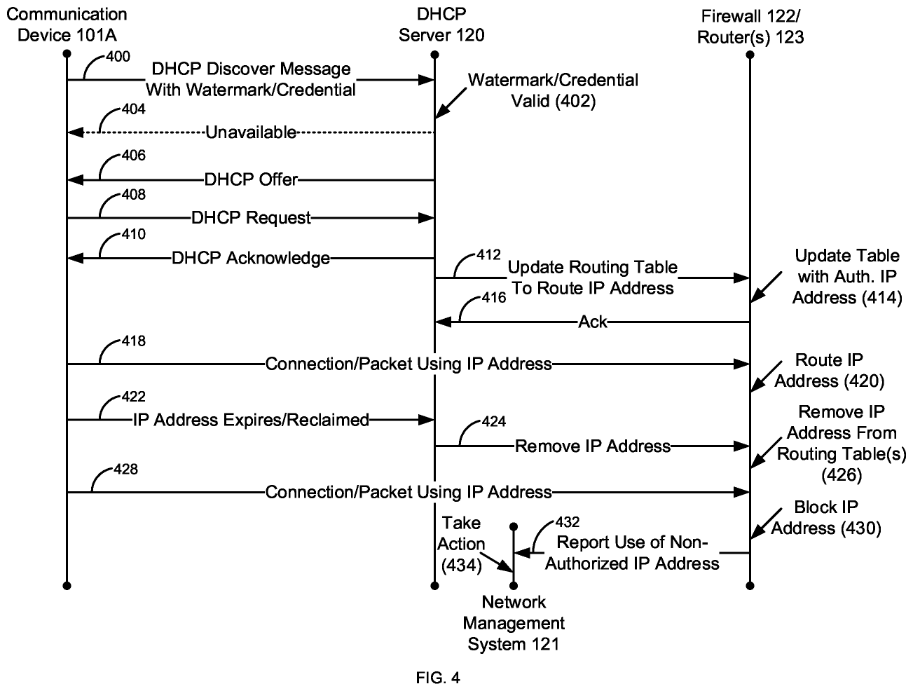

FIG. 4 is a flow diagram of a process for using watermarks with a DHCP server 120. As part of the normal DHCP process, the communication device 101A sends a DHCP Discover message in step 400. The DHCP Discover Message comprises a watermark. The DHCP Discover message of step 400 may also include a credential (e.g., like discussed above). The watermark is a known pattern that is used by legitimate device on the private network 110A. For example, if a malicious device/application requests an IP address, the DHCP Discover message will not have the watermark. The watermark may be in the client IP address field of the DHCP Discover message, the Your IP address field of the DHCP discover message, the server IP address field of the DHCP discover message, in the Sname field of the DHCP discover message, etc. Normally these fields are zeroed out in the DHCP Discover message because the communication device 101A is requesting to get an IP address. The watermark may reside in the flags field of the DHCP discover message where there are fifteen bits that are not used and normally set to zero. The watermark may use the DHCP options field that allows definition of vendor fields (i.e., the watermark). The watermark may be based on a combination of fields (e.g., the client IP address field and the Your IP address field) or a combination of fields in DHCP Discover/DHCP Request Message. The watermark may be a serialized/encrypted watermark. The watermark may be an additional field/header that sent is before or after the DHCP Discover message of step 400 in a separate message. While the message may be separate, it still can be considered as part of the DHCP discover message in the claims.

The DHCP server 120 determines, in step 402, if there is a watermark/credential (if used) in the in the DHCP Discover message. If there is not a valid watermark/credential in the DHCP Discover message of step 400, the DHCP server 120 rejects the DHCP Discover message in step 404 by sending an DHCP Offer message that indicates that an IP address is unavailable. Otherwise, if the DHCP Discover message includes the watermark, the DHCP server 120 sends a standard DHCP Offer message with the IP address to the communication device 101A in step 406. The communication device 101A responds with a standard DHCP request message in step 408. The DHCP server 120 sends a standard DHCP Acknowledgement message in step 410. At this point, the communication device 101A now has a valid IP address.

The DHCP server 120 sends an update routing table message, in step 412, to the firewall 122/router(s) 123. The firewall 122/router(s) 123 update their routing tables in step 414. The firewall 122/router(s) 123 acknowledges the update routing table message in step 416. When a connection/packet that uses the IP address is received in step 418, the firewall 122/router(s) 123 routes the packet as is normally done in step 420. The routing could also be based on a port/different address like described above. If the IP Address expires/is reclaimed in step 422, the DHCP server 120 sends a remove IP address message in step 424. The message of step 422 may be generated locally in the DHCP server 120 (e.g., where the IP address expires). The DHCP server 120 sends a remove IP address message to the firewall 122/router(s) 123 in step 424. The firewall 122/router(s) 123 removes the IP address from the routing tables in step 426.

When a connection/packet that uses the IP address is received in step 428, the firewall 122/router(s) 123 blocks the packets/connection that uses the IP address/port in step 430. The firewall 122/router(s) 123 report the use of the non-authorized IP address to the network management system 121 in step 432. The network management system 121 may then take an action based on the report of the non-authorized IP address in step 434. For example, the action may be to identify the non-authorized IP address in a log file, alert a user (e.g., via email or text), automatically bring up a graphical user interface, identify network device, shutdown a network device, shutdown an application, quarantine an application, quarantine a device, initiate a virus scan, open up a network management system 121 and display statistics associated with the non-authorized IP address, block a port on the firewall 122, and/or the like.

The process of FIG. 4 could also incorporate the authentication process of FIGS. 2-3. For example, a communication device 101A would have to have the correct watermark to get the IP address; however, the user would still have to authenticate like described in FIGS. 2-3 in order to be able to route packets through the firewall 122/router(s) 123.

The processes of FIGS. 2-4 can provide graded access based on authentication levels. For example, if the user has two authentication levels (e.g., authentication levels one and two) and the user authenticates at level one, the user may have access to the private network 110A. In this example, the messages of steps 210/312 would only be sent to the router(s) 123. If the user authenticates at level two, the user can access the Internet (e.g., public network 110B) and the private network 110A or other controlled resources (e.g., based on the IP address and a port number). In this example, the messages of steps 210/312 may comprise multiple messages. If the user has authenticated at level two, a first message would go the firewall 122 to allow outside access to the public network 110B and second message(s) would go to the router(s) 123 to allow internal access of the private network 110A.

Although the processes of FIGS. 2-4 are discussed where the authentication process is a user authentication process, the authentication process may not involve a user. For example, an application may reside on the communication device 110A (e.g., a server, an embedded device, etc.) where the application provides a digital certificate as part of the authentication process. In this case, the update routing table messages of steps 210/310 may also contain a port number used by the application in addition to the IP address. In this embodiment, the firewall 122/router(s) 123 would only allow packets to be routed where the IP address was authenticated and where the correct port number is used. An application/embedded device may also use login levels. In this embodiment, there may be limited access (e.g., corporate access) for one credential and advanced access (e.g., corporate/Internet) based on a second credential. This can be extended to the creation of in-bound/out-bound connections.

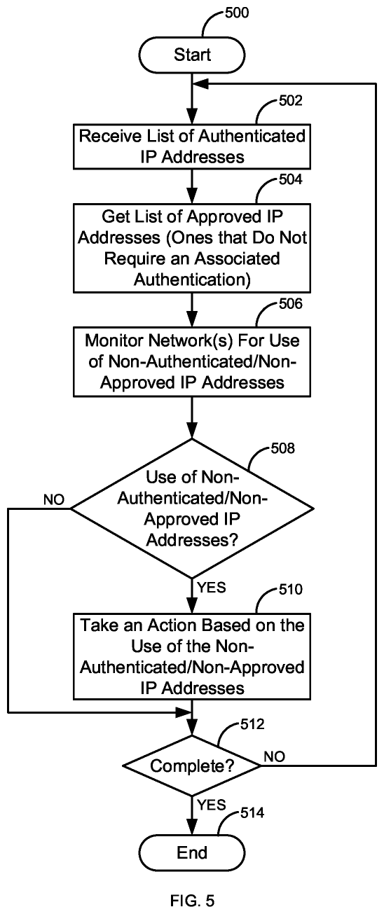

FIG. 5 is a flow diagram of a process for detecting the use of unauthorized addresses. By tracking authenticated addresses, the network management system 121 can now be used to identify malicious use of addresses.

The process starts in step 500. The network management system 121 receives, in step 502, a list of authenticated IP addresses (e.g., the addresses in the routing tables). The authenticated IP addresses of step 502 may be received from the authentication service 124 and/or the firewall 122/router(s) 123. The network management system 121 gets a list of approved IP addresses that do not require an associated authentication in step 504. The list of approved IP addresses that do not require an associated authentication may be communication devices 101 that do not support the authentication/watermark process. This list can be administered or use an algorithm that identifies the IP addresses being used. The algorithm may allow a user to select IP associated addresses/devices (e.g., MAC addresses) that are valid. For example, an IP address with a printer's MAC address will be considered an approve IP address.

The network management system 121, the firewall 122, the router(s) 123 and/or other devices (e.g., a network sniffer) monitor the private network 110A for the use of non-authenticated/non-approved IP addresses in step 506 to identify malicious use of the IP addresses. The network management system 121 determines, in step 508, if there are any non-authenticated/non-approved IP addresses being used. If there are no non-authenticated/non-approved IP addresses being used in step 508, the process goes to step 512.

Otherwise, if it is determined, in step 508, that there is use of a non-authenticated/non-approved IP address(es), the network management system 121 may take an action in step 510. For example, the action may be to identify a malicious IP address in a log file, alert a user (e.g., via email or text), automatically bring up a graphical user interface, identify network device, shutdown a network device, shutdown an application, quarantine an application, quarantine a device, block the IP address from being routed, initiate a virus scan, open up the network management system 121 and display statistics associated with the IP address, and/or the like. The process then goes to step 512.

The network management system 121 determines, in step 512, if the process is compete. If the process is complete in step 512, the process ends in step 514. Otherwise, if the process is not complete in step 512, the process goes back to step 502.

The processes described herein are discussed using IP addresses. However, the disclosure is not limited specifically to IP addresses. For example, the processes described herein could be used for any kind of associated network layer addresses, such as, Internet Packet Exchange Protocol (IPX) addresses, Q.931 addresses, X.25 addresses, and/or the like. These addresses may be configured at the authentication service 124 as profiles for a specific user/application. The process could be applied to application layer addresses/presentation layer addresses/transport layer addresses/ports etc. For example, the routing may be based on a Session Initiation Protocol (SIP) address (e.g., Global User ID (GUID), a H.323 address, a HTTP address (e.g., a Uniform Resource Locator), a telephone number, an email address, and/or the like.

The above addresses may be associated with the authentication level(s). For example, a voice/video call to a specific user (e.g., the GUID) may or may not be routed based on what authentication level the user has authenticated with. Access to a URL may be granted through the firewall 122/router(s) 123 based on the proper authentication level. These types of addresses may be used in combination with IP addresses/port numbers or separately from the IP address/port numbers. For example, the voice/video call will need an authenticated IP address and an approved GUID associated with the authentication level to actually make a call to using the GUID.

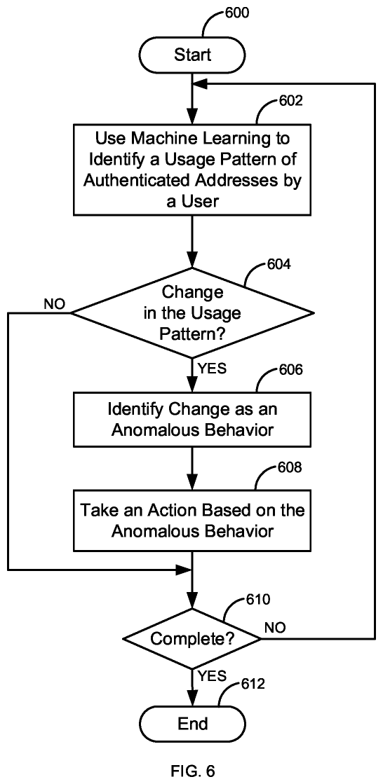

FIG. 6 is a flow diagram of a process for using machine learning to identify user usage patterns of authenticated addresses. The process starts in step 600. The machine learning module 125 uses a machine learning algorithm (e.g., an unsupervised machine learning algorithm) to identify a usage pattern of usage of authenticated addresses by a user. The machine learning module 125 may learn behavioral characteristics of how the user uses the authenticated IP address over time. For example, the machine learning module 125 may identify various applications accessed by a particular user where packets flow through the router 123 when the user is logged in at a particular authentication level to create a profile for the user. The profile may use various types of information to identify an anomaly. For example, if a connection is normally encrypted based on a login level of a user, if an unencrypted communication channel is now active when the user is logged in at authentication level two (where it is normally encrypted), this can be flagged as an anomaly.

The machine learning module 125 determines, in step 604, if there is a change in the learned usage pattern. For example, if a particular authentication level is required to use a SIP GUID and a voice call made is without the proper authentication using the SIP GUID, this can be flagged as a potential security breach. If there is not a change in the usage pattern in step 604, the process goes to step 610.

Otherwise, if a change in the usage pattern is identified in step 604, the machine learning module 125 identifies the change as an anomalous behavior in step 606. Based on the anomalous behavior, the network management system 121 may take an action based on the anomalous behavior in step 608. For example, the action may be to identify the non-authorized IP address in a log file, alert a user (e.g., via email or text), automatically bring up a graphical user interface, identify network device, shutdown a network device, shutdown an application, quarantine an application, quarantine a device, initiate a virus scan, open up a network management system 121 and display statistics associated with the non-authorized IP address, block a port on the firewall 122, and/or the like.

The process determines, in step 610 if the process is complete. If the process is not complete in step 610, the process goes back to step 602. Otherwise, if the process is complete in step 610, the process ends in step 612.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network 110, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive a request to authenticate, wherein the request to authenticate has an associated address;
validate the request to authenticate; and
in response to validating the request to authenticate, send a first message to a routing device that identifies the associated address as authenticated for routing packets.

2. The system of claim 1, wherein the request to authenticate is based on a plurality of authentication levels associated with a user, wherein a first authentication level of the plurality of authentication levels causes the first message to be sent the routing device within a private network, and wherein a second authentication level of the plurality of authentication levels causes the first message to be sent to the routing device within the private network and to a firewall connected to an external network.

3. The system of claim 1, wherein the associated address is an Internet Protocol (IP) address a provided by a Dynamic Host Configuration Protocol (DHCP) server.

4. The system of claim 1, wherein the IP address is not provided until a user logs in locally to a communication device.

5. The system of claim 1, wherein the associated address comprises at least one of: an Internet Protocol (IP) address, an Internet Packet Exchange (IPX) address, a Media Access Control (MAC) address, a transport layer application address, a presentation layer address, an application layer address, a port number of an application, a Q.931 address, a Uniform Resource Locator (URL), a H.323 address, and a Session Initiation Protocol (SIP) address.

6. The system of claim 1, wherein the request to authenticate is for a user and wherein the microprocessor readable and executable instructions further cause the microprocessor to:
detect that the user has logged out; and
in response to detecting that the user has logged out, send a second message to the routing device that identifies that the associated address as invalid for routing the packets.

7. The system of claim 1, wherein the microprocessor readable and executable instructions further cause the microprocessor to:
get a list of authenticated addresses;
monitor a network for use of one or more non-approved addresses;
identify use of the one or more non-approved addresses on the network; and
in response to identifying the use of the one or more non-approved addresses, take an action;

8. The system of claim 7, wherein the action is to at least one of: identify a malicious address in a log file, alert a user, automatically bring up a graphical user interface, identify network device, shutdown the network device, shutdown an application, quarantine the application, quarantine a device, initiate a virus scan, open up a network management system, and display statistics associated with the associated address.

9. The system of claim 1, wherein the request to authenticate is for a user and wherein the microprocessor readable and executable instructions further cause the microprocessor to:
identify a usage pattern of authenticated addresses by the user using machine learning;
identify a change to the usage pattern as an anomalous behavior; and
in response to identifying the usage pattern as an anomalous behavior, take an action.

10. A method comprising:
receiving, by a microprocessor, a request to authenticate, wherein the request to authenticate has an associated address;
validating, by the microprocessor, the request to authenticate; and
in response to validating the request to authenticate, sending, by the microprocessor, a first message to a routing device that identifies the associated address as authenticated for routing packets.

11. The method of claim 10, wherein the request to authenticate is based on a plurality of authentication levels associated with a user, wherein a first authentication level of the plurality of authentication levels causes the first message to be sent the routing device within a private network, and wherein a second authentication level of the plurality of authentication levels causes the first message to be sent to the routing device within the private network and to a firewall connected to an external network.

12. The method of claim 10, wherein the associated address is an Internet Protocol (IP) address a provided by a Dynamic Host Configuration Protocol (DHCP) server.

13. The method of claim 10, wherein the associated address comprises at least one of: an Internet Protocol (IP) address, an Internet Packet Exchange (IPX) address, a Media Access Control (MAC) address, a transport layer application address, a presentation layer address, an application layer address, a port number of an application, a Q.931 address, a Uniform Resource Locator (URL), a H.323 address, and a Session Initiation Protocol (SIP) address.

14. The method of claim 10, wherein the request to authenticate is for a user and further comprising:
detecting that the user has logged out; and
in response to detecting that the user has logged out, sending a second message to the routing device that identifies that the associated address as invalid for routing the packets.

15. The method of claim 10, comprising:
getting a list of authenticated addresses;
monitoring a network for use of one or more non-approved addresses;
identifying use of the one or more non-approved addresses on the network; and
in response to identifying the use of the one or more non-approved addresses, taking an action;

16. The method of claim 10, wherein the request to authenticate is for a user and further comprising:
identifying a usage pattern of authenticated addresses by the user using machine learning;
identifying a change to the usage pattern as an anomalous behavior; and
in response to identifying the usage pattern as an anomalous behavior, taking an action.

17. A Dynamic Host Configuration Protocol (DHCP) server comprising:
a microprocessor; and
a computer readable medium, coupled with the microprocessor and comprising microprocessor readable and executable instructions that, when executed by the microprocessor, cause the microprocessor to:
receive a DHCP discover message;
determine if the DHCP discover message comprises a watermark;
in response to determining that the DHCP discover message comprises the watermark: send a DHCP offer message with an Internet Protocol (IP) address and send a third message to a routing device that identifies the IP address as valid for routing packets.

18. The DHCP server of claim 17, wherein the watermark is in at least one of: a client address field in the DHCP discover message, a your IP address field in the in the DHCP discover message, a server IP address field in the in the DHCP discover message, a Sname field in the in the DHCP discover message, a flags field in the in the DHCP discover message, a DHCP options field in the in the DHCP discover message, a combination of fields in the in the DHCP discover message, a proprietary field in the in the DHCP discover message, and in a separate message.

19. The DHCP server of claim 1, wherein the microprocessor readable and executable instructions further cause the microprocessor to:
determine that the DHCP discover message does not have the watermark;
in response to determining that the DHCP discover message does not have the watermark, send an unavailable message.

20. The DHCP server of claim 1, wherein the IP address further comprises at least one of: a Media Access Control (MAC) address, a port number of an application, a transport layer application address, a presentation layer address, an application layer address, a Q.931 address, a (Universal Resource Locator URL), a H.323 address, and a Session Initiation Protocol (SIP) address.
